(19) United States
(12) Patent Application Publication
(10) Pub. No.: US 2014/0209656 A1
(43) Pub. Date: Jul. 31, 2014

(54) NAIL GUN STRUCTURE

(71) Applicant: Yi-Chang Wu, Taichung City (TW)

(72) Inventor: Yi-Chang Wu, Taichung City (TW)

(21) Appl. No.: 13/754,825

(22) Filed: Jan. 30, 2013

(51) Int. Cl. B25C 1/04

(52) U.S. Cl. CPC B25C 1/047
USPC 227/8

(57) ABSTRACT

A nail gun structure includes a main body, a seat, an actuating button and a driving cable. The main body has a trigger member for shooting a nail. One end of the seat is assembled at a rear end of the main body. The actuating button is assembled at another end of the seat. One end of the driving cable is assembled to the trigger member of the main body, and another end of the driving cable is assembled to the actuating button. Under this arrangement, when a user holds the seat and presses down the actuating button, the actuating button drives the driving cable to trigger the trigger member so as to shoot the nail.

### BACKGROUND OF THE INVENTION

1. Field of the Invention

The present invention relates to a hand tool, and more particularly to a nail gun structure.

2. Description of Related Art

In order to cover the ground with sheet plates, such as wood floor plates, a foundation plate is covered onto a surface of the ground firstly; and then, the sheet plates are stacked onto the foundation plate; thereby, a nail is inserted into each sheet plate and the foundation plate from a lateral side of said sheet plate so as to fix said sheet plate on the foundation securely; thereafter, by repeating the steps mentioned above, the sheet plates are covered onto the ground for decoration.

A conventional nail gun structure is triggered by a rubber hammer so that the nail is inserted into the sheet plate and the foundation plate. When operating, a user holds the conventional nail gun structure and the hammer with his two hands respectively; then, the user beats an end portion of the conventional nail gun structure with the hammer so as to trigger the nail; thereby, by repeating the steps mentioned above, the sheet plates are covered onto the ground.

However, the conventional nail gun structure has three disadvantages as following.

Firstly, during the operation, the user needs to check whether an insertion point of the nail and the arrangement of the sheet plates is suitable; so the user has to operate the hammer and the conventional nail gun structure simultaneously with eyes staring on the nail or the sheets plates; as a result, operating the conventional nail gun structure is inconvenient and hard.

Secondly, in order to trigger the conventional nail gun structure, the hammer is essential for the operation, so that the user needs to take along the hammer during the operating time which is an extra burden for the user.

Thirdly, covering the sheet plates takes time and manpower; in addition, the user has to repeatedly beat the conventional nail gun structure with the hammer which is heavy typically, so that the user gets muscle soreness easily after the operation.

The present invention has arisen to mitigate and/or obviate the disadvantages of the conventional.

### SUMMARY OF THE INVENTION

The main objective of the present invention is to provide a nail gun structure.

To achieve the objective, a nail gun structure comprises a main body, a seat, an actuating button and a driving cable, the main body having a trigger member for shooting a nail, one end of the seat assembled to a rear portion of the main body, another end of the seat assembled to the actuating button, one end of the driving cable assembled to the trigger member of the main body, another end of the driving cable assembled to the actuating button. Wherein, the seat has an assembling segment and an extending segment; the extending segment forms at one side of the assembling segment; the extending segment has a grip portion assembled thereon; the actuating button is pivotally assembled to the extending segment and is near to the grip portion; the extending segment has a supporting member assembled thereon; the actuating button is pivotally assembled to the supporting member; two ends of an elastic member are elastically abutted against the grip portion and the actuating button respectively; the grip portion has an engaging stem protruded outwardly therefrom; one end of the elastic member sleeves on the engaging stem; the extending segment has a plurality of buckle members assembled thereon; the driving cable is buckled on the extending segment via the buckle members which are defined spacingly; the extending segment has a groove extended toward the assembling segment; the driving cable is received into the groove; the seat is fastened with the rear portion of the main body via a plurality of screws; the extending segment has a via hole opened therethrough; one end of the grip portion is inserted into the via hole securely; an angle is defined between the assembling segment and the extending segment; the trigger member has a driving member assembled at one side thereof. The driving member is assembled to the driving cable.

Under this arrangement, when a user holds the seat and presses the actuating button, the actuating button drives the driving cable to trigger the trigger member so as to shoot the nail.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a nail gun structure of the present invention;

FIG. 2 is a perspective view of the nail gun structure;

FIG. 3 is another perspective view of the nail gun structure;

FIGS. 4 and 5 are schematic views for showing that a nail is triggered by the present invention so that the nail penetrates a sheet and a foundation so as to fix the sheet onto the foundation securely;

FIG. 6 is a schematic view of the present invention for showing the relationship between the actuating button and the driving cable; and

FIG. 7 is a schematic view for showing that an actuating button of the present invention is pressed by a user.

### DETAILED DESCRIPTION OF THE INVENTION

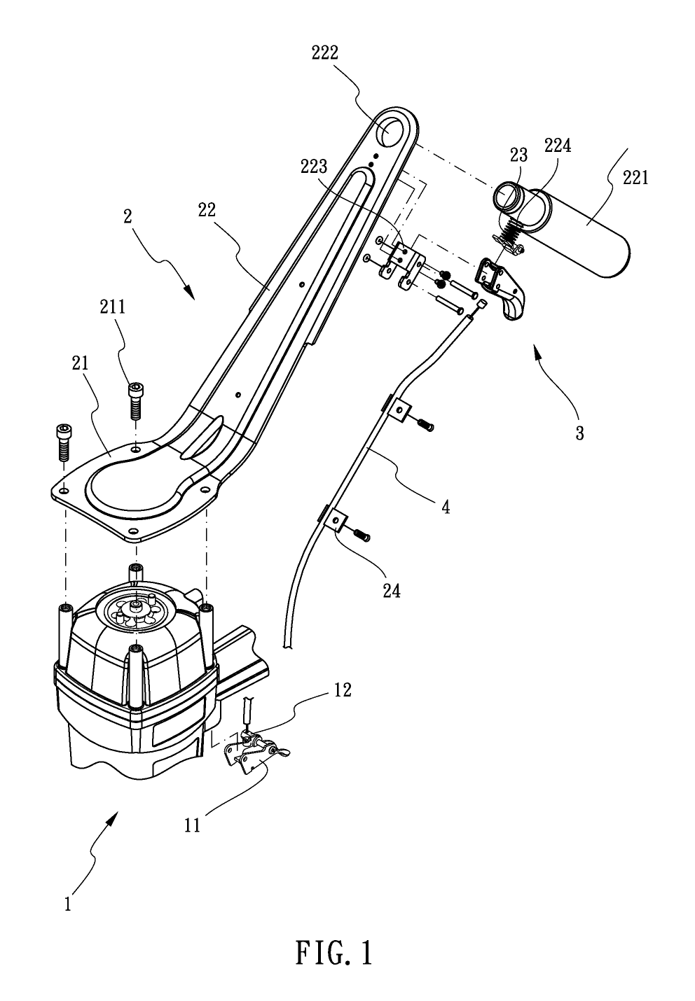

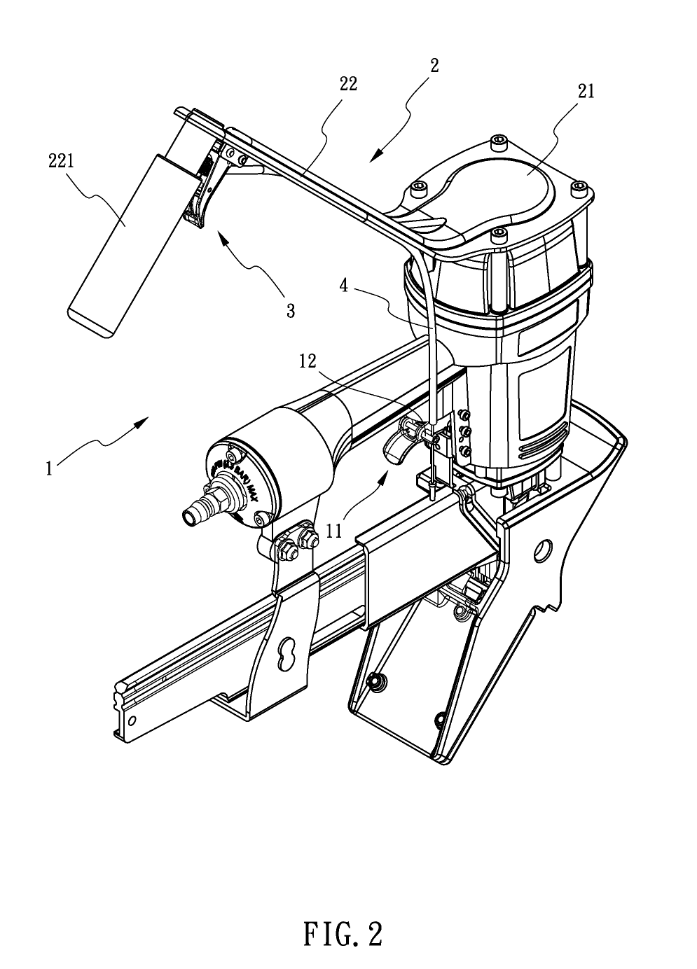

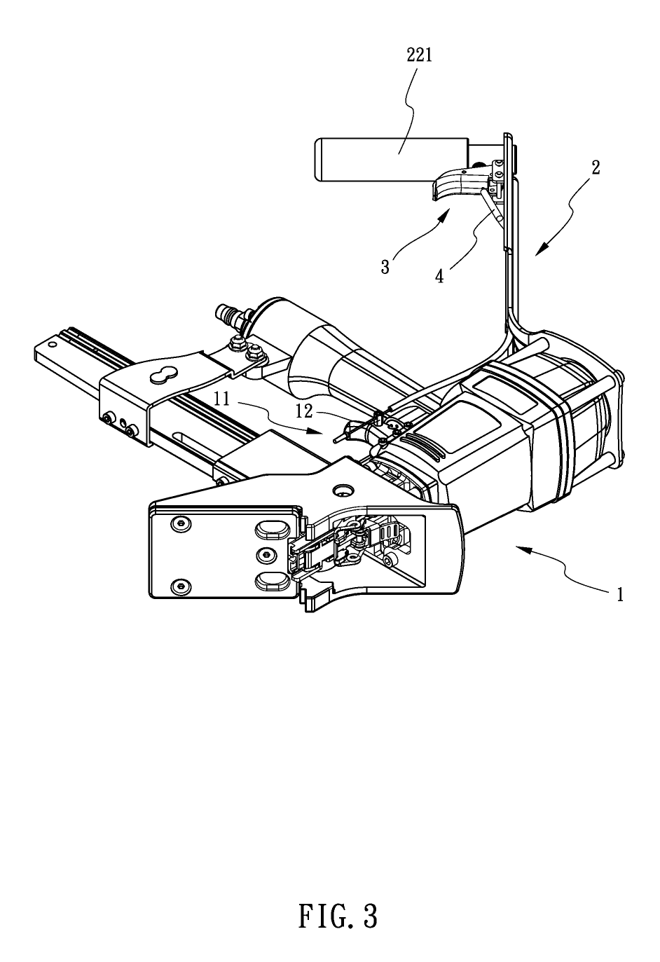

Referring to FIGS. 1-3, a nail gun structure in accordance with the present invention comprises a main body 1, a seat 2, an actuating button 3 and a driving cable 4.

The main body 1 has a trigger member 11 for shooting a nail 52. One end of the seat 2 is assembled to a rear portion of the main body 1, and another end of the seat 2 is assembled to the actuating button 3. One end of the driving cable 4 is assembled to the trigger member 11 of the main body 1, and another end of the driving cable 4 is assembled to the actuating button 3.

Under this arrangement, when a user holds the seat 2 and presses the actuating button 3, the actuating button 3 drives the driving cable 4 to trigger the trigger member 11 so as to shoot the nail 52. The details of the present invention are further described as following.

Referring to FIGS. 1-3, the trigger member 11 has a driving member 12 assembled at one side thereof. The driving member 12 is assembled to the driving cable 4. The seat 2 further has an assembling segment 21 and an extending segment 22. The extending segment 22 forms at one side of the assembling segment 21. An angle is defined between the assembling segment 21 and the extending segment 22. The extending segment 22 extends away from the trigger member 11. The seat 2 is fastened with the rear portion of the main body 1 via a plurality of screws 211.

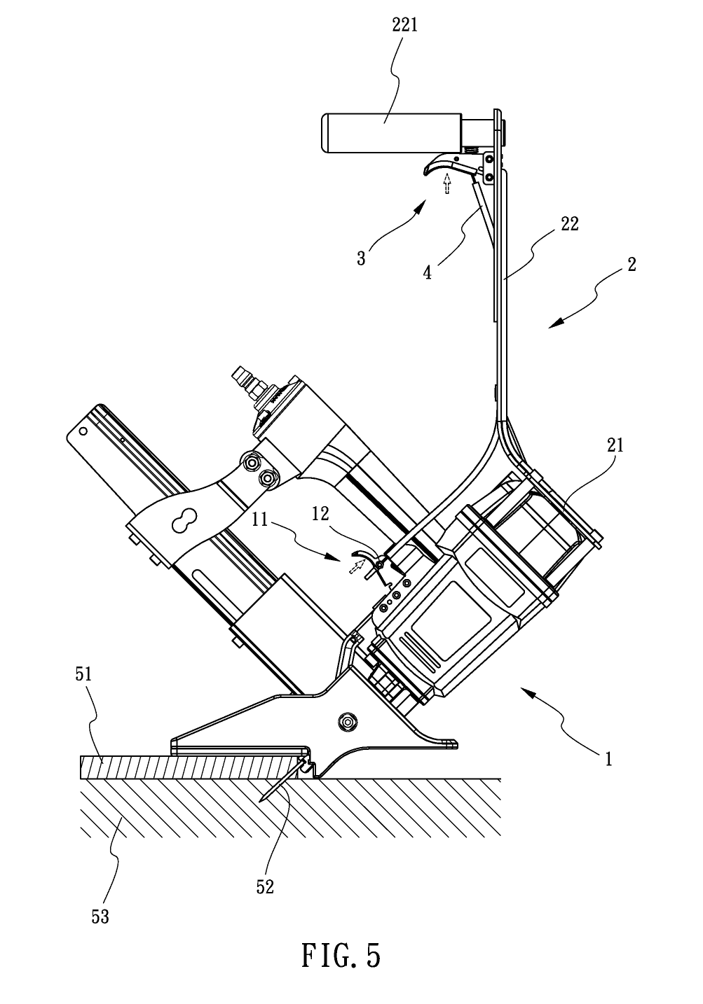

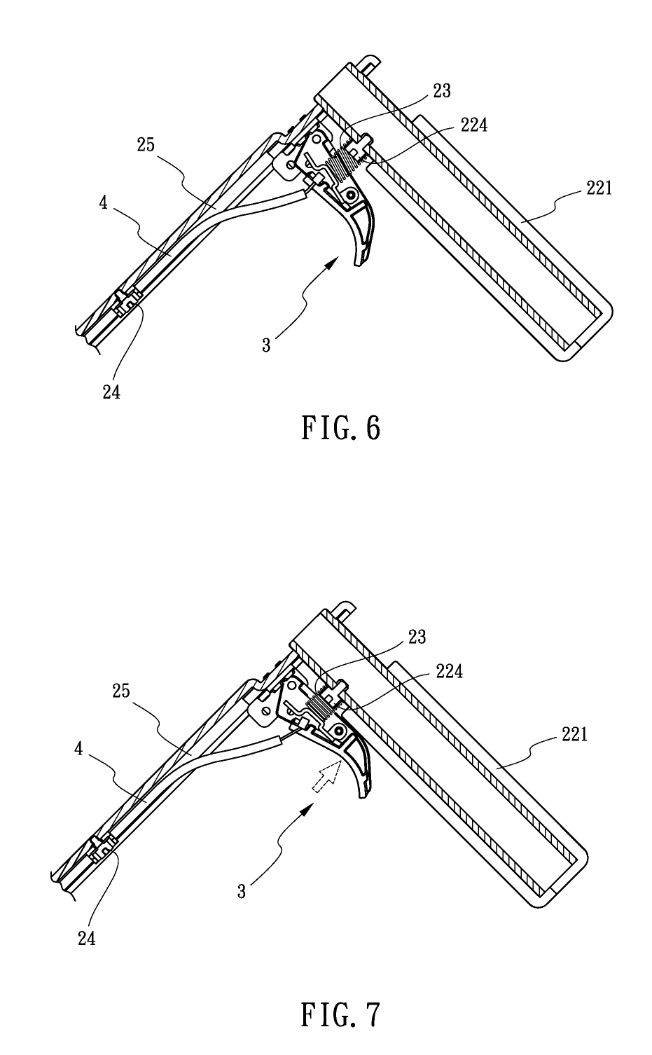

The extending segment 22 further has a grip portion 221 assembled thereon and a via hole 222 opened therethrough. One end of the grip portion 221 is inserted into the via hole 222 securely. The actuating button 3 is pivotally assembled to the extending segment 22 and is near to the grip portion 221. The extending segment 22 further has a supporting member 223 assembled thereon. The actuating button 3 is pivotally assembled to a supporting member 223. Two ends of an elastic member 23 are elastically abutted against the grip portion 221 and the actuating button 3 respectively. The grip portion 221 has an engaging stem 224 protruded outwardly therefrom. One end of the elastic member 23 sleeves on the engaging stem 224. The extending segment 22 has a plurality of buckle members 24 assembled thereon. The driving cable 4 is buckled on the extending segment 22 via the buckle members 24 which are defined spacingly. The extending segment 22 has a groove 25 extended toward the assembling segment 21, so that the driving cable 4 is received into the groove 25, as shown in FIGS. 6-7.

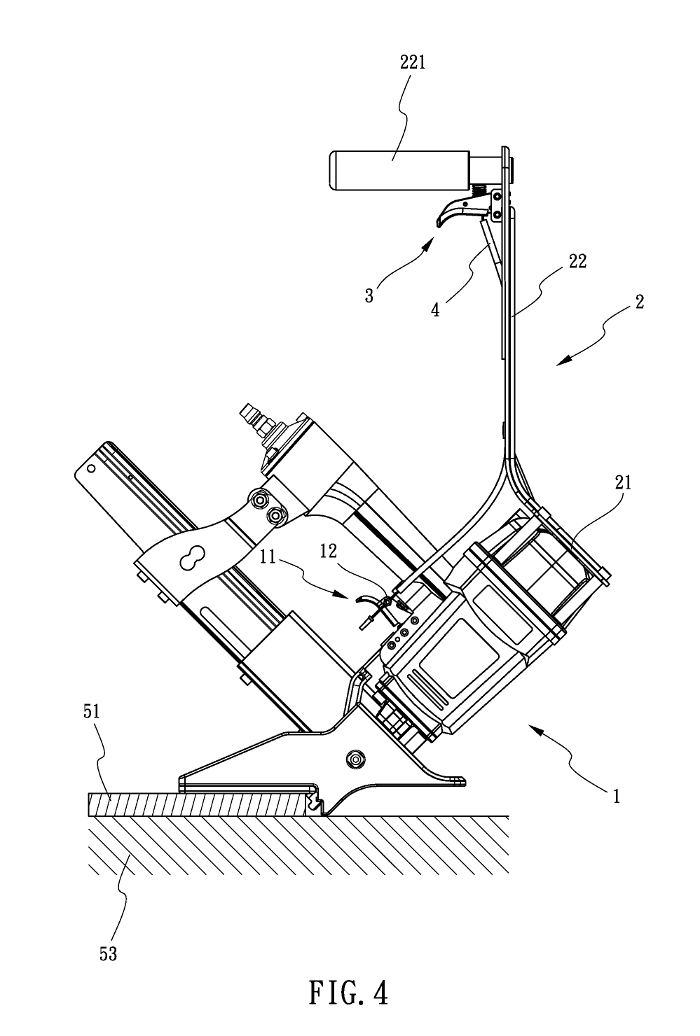

Referring to FIGS. 4-7, the operation method of the present invention is explained in detail. The user holds the present invention via the grip portion 221 with one hand so as to move the present invention, so that a nail outlet (not numbered) of the present invention is aimed to a lateral side of a sheet plate 51 which is stacked on a foundation plate 53 firstly; and then, the user presses the actuating button 3 with the same hand so as to compress the elastic member 23 to pull the driving cable 4; simultaneously, the driving cable 4 triggers the trigger member 11 via the driving member 12; thereby, the nail 52 is shot from the nail outlet and is inserted into the sheet plate 51 and the foundation plate 53, so that the sheet plate 51 is fixed on the foundation plate 53 securely. When the user releases the actuating button 3, the actuating button 3 is resiliently moved to an original position via the elastic member 23. By repeating the steps mentioned above, the user covers the sheet plates 51 on the ground for decoration.

All in all, the present invention has following advantages.

Firstly, the user just uses one hand to hold the present invention, so that operating the present invention is labor-saving, convenient and easy.

Secondly, as compared to the conventional nail gun structure in which a hammer is essential, the hammer is no longer necessary for the present invention.

Although the invention has been explained in relation to its preferred embodiment, it is to be understood that many other possible modifications and variations can be made without departing from the spirit and scope of the invention as hereinafter claimed.

What is claimed is:

1. A nail gun structure comprising:
a main body, a seat, an actuating button and a driving cable; and
the main body having a trigger member for shooting a nail, one end of the seat assembled to a rear portion of the main body, another end of the seat assembled to the actuating button, one end of the driving cable assembled to the trigger member of the main body, another end of the driving cable assembled to the actuating button;
wherein when a user holds the seat and presses the actuating button, the actuating button drives the driving cable to trigger the trigger member so as to shoot the nail.

2. The nail gun structure as claimed in claim 1, wherein the seat has an assembling segment and an extending segment; the extending segment forms at one side of the assembling segment; the extending segment has a grip portion assembled thereon; the actuating button is pivotally assembled to the extending segment and is near to the grip portion.

3. The nail gun structure as claimed in claim 2, wherein the extending segment has a supporting member assembled thereon; the actuating button is pivotally assembled to the supporting member; two ends of an elastic member are elastically abutted against the grip portion and the actuating button respectively.

4. The nail gun structure as claimed in claim 3, wherein the grip portion has an engaging stem protruded outwardly therefrom; one end of the elastic member sleeves on the engaging stem.

5. The nail gun structure as claimed in claim 2, wherein the extending segment has a plurality of buckle members assembled thereon; the driving cable is buckled on the extending segment via the buckle members which are defined spacingly.

6. The nail gun structure as claimed in claim 2, wherein the extending segment has a groove extended toward the assembling segment; the driving cable is received into the groove.

7. The nail gun structure as claimed in claim 2, wherein the seat is fastened with the rear portion of the main body via a plurality of screws.

8. The nail gun structure as claimed in claim 2, wherein the extending segment has a via hole opened therethrough; one end of the grip portion is inserted into the via hole securely.

9. The nail gun structure as claimed in claim 2, wherein an angle is defined between the assembling segment and the extending segment.

10. The nail gun structure as claimed in claim 1, wherein the trigger member has a driving member assembled at one side thereof. The driving member is assembled to the driving cable.
